(19) United States
(12) Patent Application Publication
(10) Pub. No.: US 2024/0341515 A1
(43) Pub. Date: Oct. 17, 2024

(54) PUNCH-FREE TELESCOPIC ROD

(71) Applicant: Shandong Yijiale Smart Home Technology Co., Ltd., Yantai City (CN)

(72) Inventor: Zengjie Yu, Longkou City (CN)

(21) Appl. No.: 18/755,399

(22) Filed: Jun. 26, 2024

(30) Foreign Application Priority Data
Jun. 7, 2024 (CN) 202410742169.8

(51) Int. Cl. A47H 1/022

(52) U.S. Cl. CPC A47H 1/022

(57) ABSTRACT

The present invention discloses a punch-free telescopic rod, comprising an inner tube and an outer tube sleeved together. A first elastic part is connected to the inner tube. When the two tubes rotate relative to each other, the first elastic part and the insertion end squeeze each other to lock the two tubes; when the two tubes rotate in opposite directions, the first elastic part and the end face of the insertion end are separated from each to unlock the two tubes. The structure of the present invention is very simple and can achieve stable locking.

### TECHNICAL FIELD

The present invention relates to telescopic rods, in particular to punch-free telescopic rods.

### BACKGROUND TECHNOLOGY

A manual telescopic rod is widely used, such as a curtain rod and a door curtain rod, wherein two rod-shaped components are sleeved together and can achieve relative sliding, and there is a locking mechanism between them. Specifically, when the two rod-shaped components are retracted or extended relative to each other, they can be locked by the locking mechanism, thereby realizing telescoping function. For example, a Chinese utility model patent (CN208951048U) discloses a locking structure of a telescopic rod, which is provided with a connecting locking sleeve at the connection between the outer tube and the inner tube, and achieves locking through the installed bolts. The structure is relatively complex, and the external locking structure affects the integrity of the telescopic rod.

### SUMMARY

The present invention provides a punch-free telescopic rod which is designed to solve the deficiencies of the above-mentioned technology.

The punch-free telescopic rod consists an inner tube and an outer tube which are sleeved together, the inner tube extends into the ends of the outer tube, used as an insertion end and provided with a positioning member, the positioning member is slidably connected with a first elastic part, so that the first elastic part can move back and forth along the positioning member in the same axial direction as the inner tube, and the first elastic part has static friction with the inner wall of the outer tube. When the inner tube and the outer tube rotate relative to each other, the outer tube drives the first elastic part to move along the positioning member toward the insertion end of the inner tube until the first elastic part and the end face of the insertion end squeeze each other, and in this case, the first elastic part elastically deforms, pressing against the inner wall of the outer tube so that the inner tube and the outer tube are mutually locked, and there is no relative axial displacement between the two; When the inner tube and the outer tube rotate in opposite directions, the outer tube drives the first elastic part to move away from the insertion end along the positioning member until the first elastic part and the end face of the insertion end are separated, and the first elastic part restores from the elastic deformation to unlock the outer tube and the inner tube, and thus both the outer tube and the inner tube can move at this time.

The technical effect of the present invention is that the end of the inner tube extending into the outer tube is provided with a threaded stud which can be screwed with a threaded sleeve. A first elastic part is provided at the top of the threaded sleeve and a second elastic part is movably sleeved over the threaded stud. Static friction may form between the first elastic part and the inner wall of the outer tube. When the tubes are rotated, the external tube drives the first elastic part to rotate, and the first elastic part drives the threaded sleeve to rotate, so that the threaded sleeve rotates over the threaded stud, and finally the first elastic part reach the second elastic part and the two squeeze each other, and deform. Then, the two deforming elastic parts tightly press against the inner wall of the outer tube, so that the outer tube and the inner tube are mutually locked. Rotating the outer tube in the opposite direction can unlock the two tubes. Therefore, the inner tube and the outer tube can be locked at any position after they are shortened or lengthened. The present invention not only has a simple structure without need of too much machining, but also can achieve quite stable locking.

### BRIEF DESCRIPTION OF THE DRAWINGS

FIG. 1 is an overall structure diagram of the present invention;

FIG. 2 is an overall structure explosion diagram of the present invention;

FIG. 3 is an enlarged view of point A in FIG. 2;

FIG. 4 is a cross-sectional view of the structure when two elastic parts squeeze each other;

FIG. 5 is an enlarged view of point B in FIG. 4;

FIG. 6 is a cross-sectional view of the structure when the first elastic part and the second elastic part are separated from each other;

FIG. 7 is a structural diagram of the threaded sleeve and the first elastic part;

FIG. 8 is a structural diagram of the threaded sleeve with a tube-like base body and a buffer block;

FIG. 9 is a three-dimensional structural diagram of the tube-like base body and the buffer block.

Description of reference numerals: 1—inner tube; 11—insertion end; 2—outer tube; 3—first elastic part; 31—base; 32—elastic sheet; 33—through hole; 34—limiting notch; 4—threaded stud; 5—threaded sleeve; 51—internal threaded hole; 6—second elastic part; 7—tube-like base body; 8—buffer block.

### DESCRIPTION OF THE EMBODIMENTS

### Embodiment 1

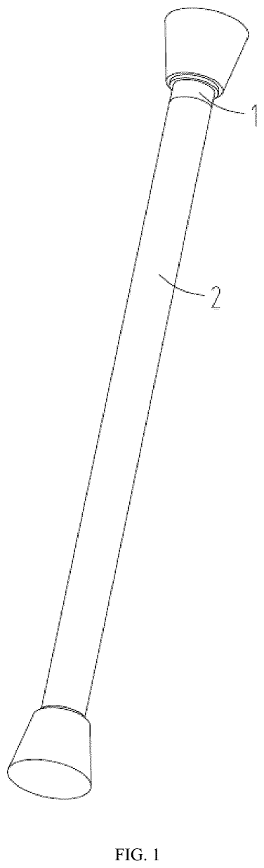

As shown in FIG. 1, the present invention comprises an inner tube 1 and an outer tube 2

which are sleeved together. One end of the inner tube 1, used as an insertion end 11, is inserted into the outer tube 2. The insertion end 11 is provided with a positioning member, a first elastic part 3 is slidably connected to the positioning member, the first elastic part 3 can axially move back and forth along the positioning member, that is, the first elastic part 3 can move close to and away from the end face of the insertion end 11. There is static friction between the first elastic part 3 and the inner wall of the outer tube 2. When the outer tube body is rotated or axially moved, the outer tube body can drive the first elastic part 3 to rotate or axially move, namely, the outer tube 2 and the first elastic part 3 move synchronously. When the inner tube 1 and the outer tube 2 are driven to rotate relative to each other, the first elastic part 3 will move toward the end face of the insertion end 11 under the action of static friction. After contacting the end face of the insertion end 11, the first elastic part 3 will continue to move, causing that the first elastic part 3 and the end face of the insertion end 11 squeeze each other. At this time, the first elastic part 3 will deform elastically, with its outer peripheral wall tightly pressing against the inner wall of the outer tube 2, so that the two form a tight fit, thus the inner tube 1 and the outer tube 2 are mutually locked, with no axial displacement. In this way, the inner tube 1 and the outer tube 2 may be mutually locked after they are moved axially, and the distance between the outer end of the inner tube 1 and the outer end of the outer tube 2 can be adjusted to change the length of the telescopic rod.

The positioning member includes a threaded stud 4 and a threaded sleeve 5. The threaded stud 4 is located in the center of and integrated with the insertion end 11, and in the same axial direction as the inner tube 1. The threaded stud 4 is provided with external threads, and the threaded sleeve 5 is provided with an internally-threaded hole 51. The threaded sleeve 5 and the threaded stud 4 can be screwed together. The first elastic part 3 is connected to one end of the threaded sleeve 5 facing the insertion end 11, so that the threaded sleeve 5 can move together with the first elastic part 3.

The first elastic part 3 includes a base 31 and a plurality of elastic sheets 32 distributed around the base 31 at a certain interval. A through hole 33 is provided in the base 31, that is, the base 31 is of a tube-like structure. The first elastic part 3 is fixedly connected to the top of the threaded sleeve 5 through the base 31. The through hole 33 of the base 31 and the internal threaded hole of the threaded sleeve 5 are axially through. A plurality of elastic sheets 32 are distributed along the base 31, forming a radial shape. Each elastic sheet 32 is arranged outwardly inclined relative to the base 31. A plurality of elastic sheets 32 form a bowl-shaped first elastic part 3. When the first elastic part 3 is squeezed and elastically deforms, the suspended ends of the elastic sheets 32 will open outward, pressing against the inner wall of the outer tube 2, so that the ends of the elastic sheets 32 facing the inner wall of the outer tube 2 form a tight lock against the inner wall of the outer tube 2.

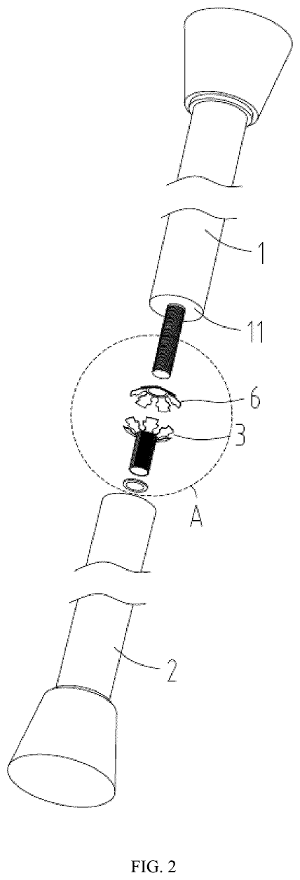

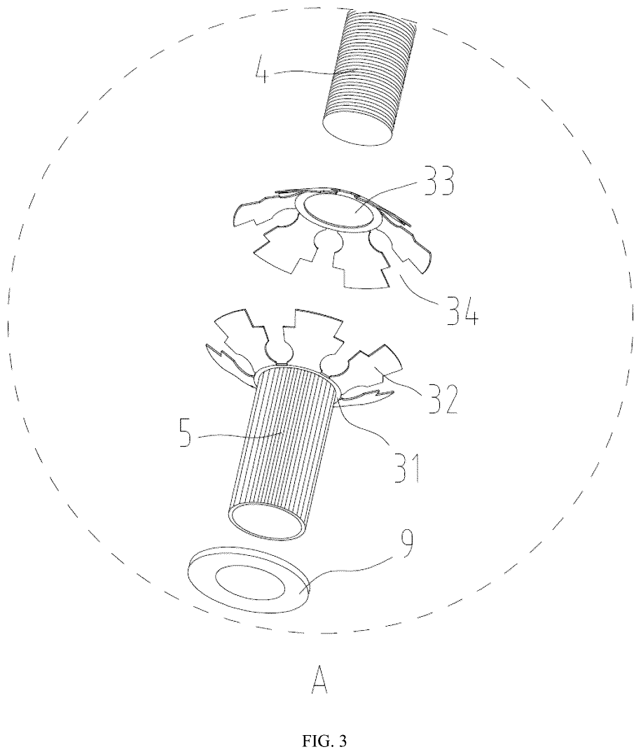

The positioning member also includes a second elastic part 6. As shown in FIG. 2 and FIG. 3, the second elastic part 6 has the same structure as the first elastic part 3, and also has a base 31 and elastic sheets 32. A through hole 33 is provided in the base 31 as well. The elastic sheets 32 of the second elastic part 6 are also distributed to form a bowl-shaped structure. The second elastic part 6 is movably sleeved over the threaded stud 4 through the through hole 33. The two elastic parts are arranged oppositely. When the outer tube 2 drives the first elastic part 3 to move along the positioning member toward the insertion end 11 of the inner tube 1, the second elastic part 6 will press against the end face of the insertion end 11, the elastic sheets 32 of the two elastic parts squeeze each other, causing their deformation and opening at the same time and pressing against the inner wall of the outer tube 2. That is, the ends with larger opening of the two elastic parts are arranged opposite to each other, so that when the two elastic parts squeeze each other, the top of the elastic sheets 32 will expand outward and open, pressing against the inner wall of the outer tube 2, as the result the inner tube 1 and the outer tube 2 are mutually locked. In this case, the two elastic parts form the status that the two layers of elastic sheets 32 tightly contacting each other, producing an elastic deformation strength is greater, but also the locking is more stable.

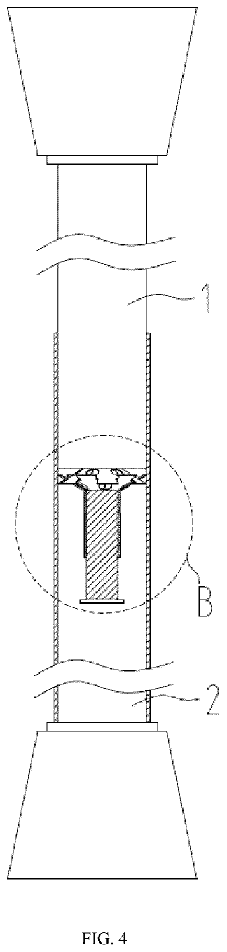

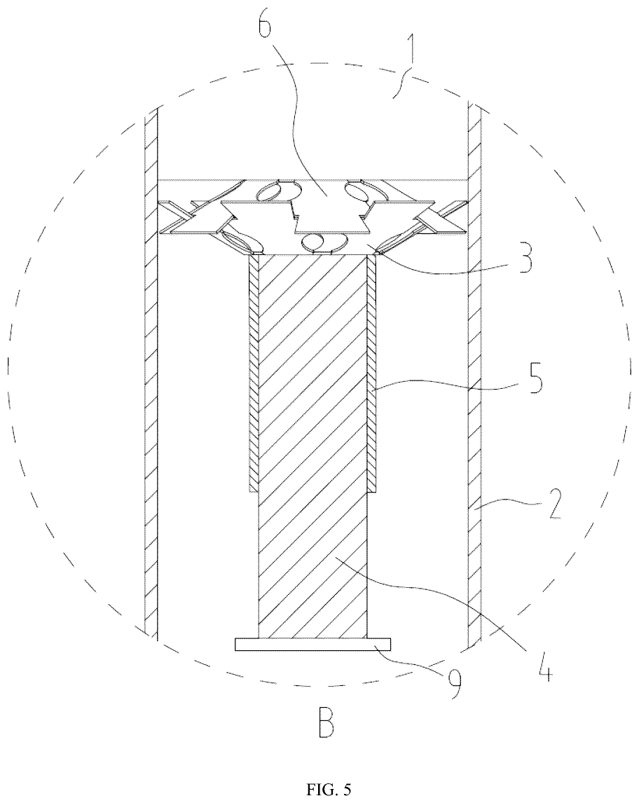

As shown in FIG. 4 and FIG. 5, the second elastic part 6 is movably connected to the threaded stud 4 and limited to the end of the outer tube 2 where the threaded stud 4 is located; the first elastic part 3 is fixed to the top of the threaded sleeve 5, and the internal threaded hole of the threaded sleeve 5 runs through the through hole 33 of the first elastic part 3. When the inner tube 1 and the outer tube 2 extend and retract by relative rotation, the end face of the insertion end 11 will be limited to the second elastic part 6, and the threaded stud 4 will go through the internal threaded holes of the first elastic part 3 and the threaded sleeve 5 at the same time, forming threaded connection with the threaded sleeve 5. When the two tubes continue to rotate relative to each other, the threaded sleeve 5 will move along the threaded stud 4 toward the insertion end 11, so that the first elastic part 3 moves toward the second elastic part 6 along with the threaded sleeve 5 until the two elastic parts are relatively squeezed, and the first elastic part 3 is elastically deformed, thereby locking the two tubes.

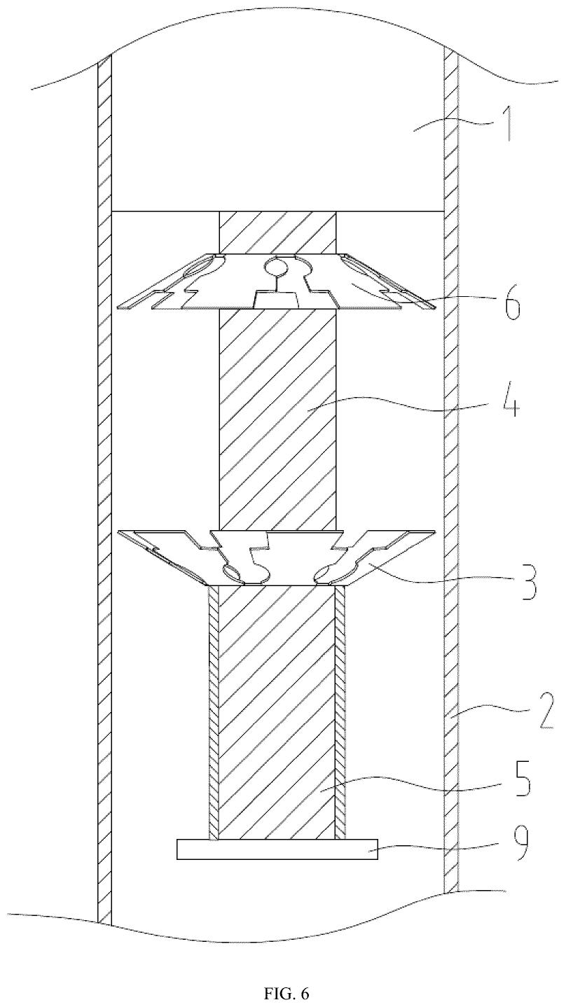

When the inner tube 1 and the outer tube 2 rotate relative to each other and move axially to make the telescopic rod become short, the threaded sleeve 5 and the threaded stud 4 are tightened relative to each other, and the first elastic part 3 on the threaded sleeve 5 will push the second elastic part 6 on the threaded stud 4, so that the second elastic part 6 moves along the threaded stud 4 to the bottom end of the threaded stud 4, namely, the end face of the insertion end 11. At this time, the second elastic part 6 has touched the bottom, and the two elastic parts are forced to squeeze each other, so that they are elastically deformed, pressing against the inner wall of the outer tube 2 to achieve locking; as shown in FIG. 6, when the inner tube 1 and the outer tube 2 rotate relative to each other, and axially move to make the telescopic rod extend, the threaded sleeve 5 and the threaded stud 4 are relatively loosened, namely, the threaded sleeve 5 and the threaded stud 4 move relatively far away from each other. At this time, the first elastic part 3 moves away from the second elastic part 6 together with the threaded sleeve 5. Then the inner tube 1 and the outer tube 2 are rotated, and the first elastic part 3 is driven by the outer tube 2 to rotate. The first elastic part 3 drives the threaded sleeve 5 to rotate, and the threaded sleeve 5 and the threaded stud 4 are screwed with each other. As the threaded sleeve 5 rotates continuously, the first elastic part 3 gets closer and closer to the second elastic part 6 until the two elastic parts touch and squeeze each other to achieve locking. That is, when the inner tube 1 and the outer tube 2 retract and extend relative to each other, they can be locked by the elastic deformation of the two elastic parts, namely when the two elastic parts collide with each other and expand, the outer peripheral wall of at least one of the two elastic parts forms a tight-fit locking with the inner wall of the outer tube 2.

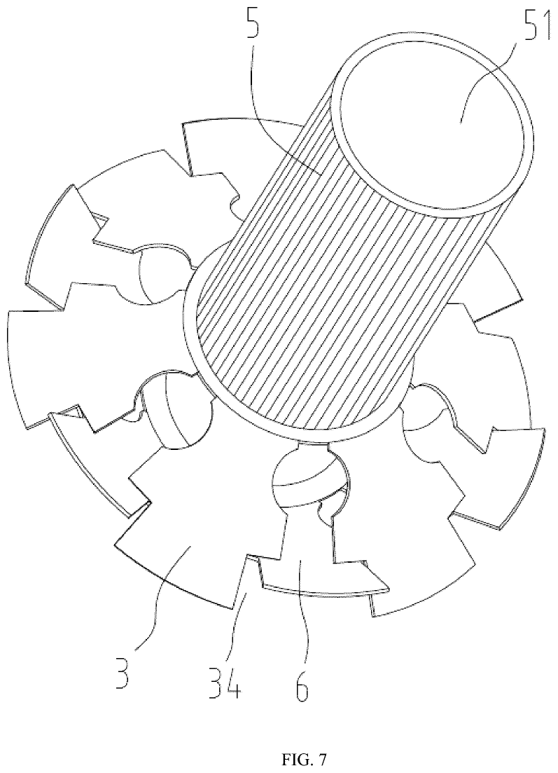

As shown in FIG. 7, a limiting notch 34 is formed between two adjacent elastic sheets 32 with the width size equal to or larger than the width size of the elastic sheet 32. When the elastic sheets 32 of two elastic parts 6 are inserted into each other's limiting notch 34, a cross limit is formed so that a rotation limit is formed between the two elastic parts. The advantages of this design are as follows: It can avoid the relative rotation of the two elastic parts, and the extrusion deformation between the two elastomers is more labor saving, and only a small rotation amplitude is needed to achieve a larger elastic deformation of the two elastic parts, making the locking more stable.

The elastic sheets 32 of the two elastic parts are made of metal, such as stainless steel, which have high strength and can achieve certain elastic deformation, high overall strength, and more firm locking.

The end of threaded stud 4 away from the insertion end 11 is provided with a stopper 9, which is fixed to the end of threaded stud 4 with a nut to prevent the threaded sleeve 5 and two elastic parts from detaching from the threaded stud 4.

### Embodiment 2

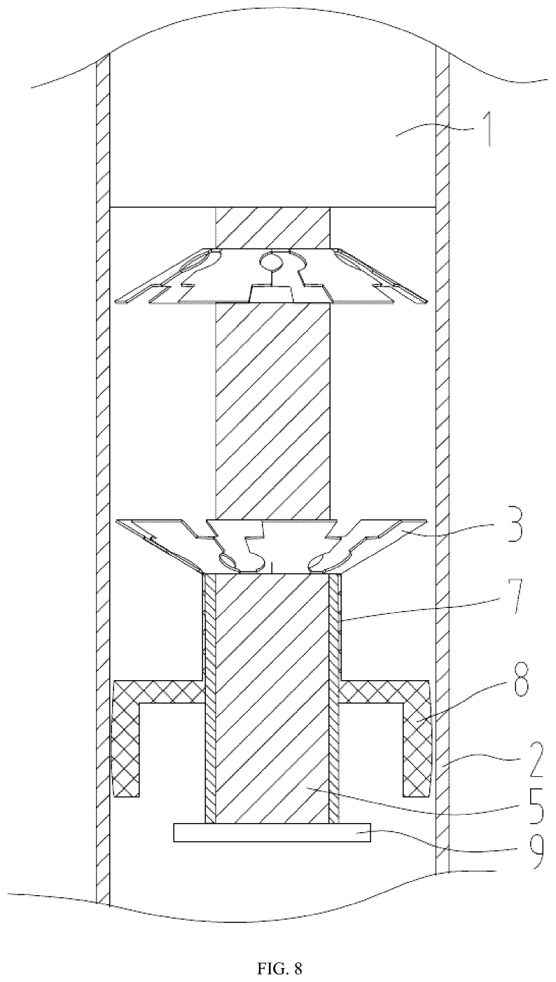

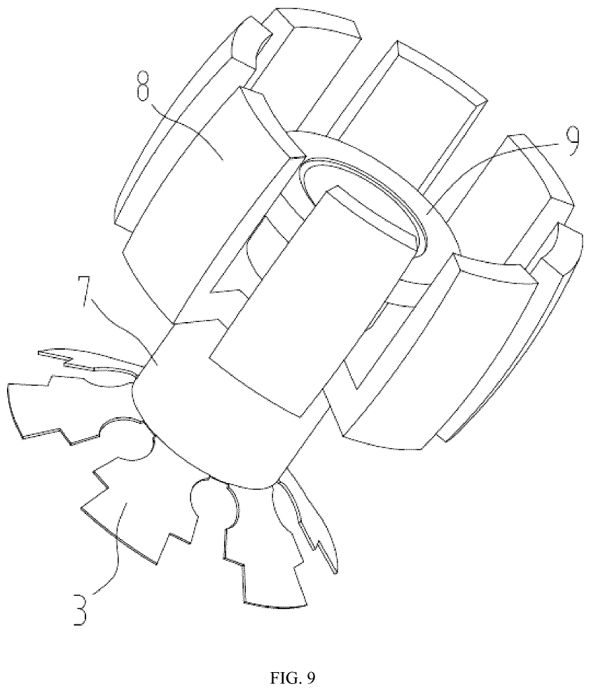

As shown in FIG. 8 and FIG. 9, the basic content is the same as that of Embodiment 1. The difference is that the threaded sleeve 5 is connected with a tube-like base body 7, and a plurality of buffer blocks 8 are distributed around the tube-like base body 7, forming a radial bowl-shaped structure. Besides, they press against the inner wall of the outer tube 2 at the same time. The buffer block 8 and the tube-like base body 7 are integrated, the material of which is usually a plastic with a property of elastic deformation, the elastic sheets 32 are radially outward, and the two elastic parts are formed by enclosing of a plurality of elastic sheets 32, and the outer diameter of the two elastic parts is less than the outer diameter formed by a plurality of buffer blocks 8, therefore, when the elastic parts and the inner wall of the outer tube 2 rotate or move with the static friction, the friction occurs first between the buffer block 8 and the inner wall of the outer tube 2. The friction noise between the buffer block 8 and the inner wall of the outer tube 2 is very small, so the friction noise between the elastic sheets 32 and the inner wall of the outer tube 2 can be avoided.

A plurality of buffer blocks 8 form a claw structure, and each of them is flexible and has a certain elastic deformation relative to the tube-like base body 7, which can not only reduce the friction noise between the inner wall of the outer tube 2, but also has an elastic buffer to avoid the jamming between the buffer block 8 and the inner wall of the outer tube 2. The buffer block 8 may also be a ring, the outer diameter size of which is larger than the elastic parts to reduce the friction noise between it and the inner wall of the outer tube 2. The stopper 9 on the threaded stud 4 prevents the buffer block 8 along with the threaded sleeve 5 from being detached from threaded stud 4.

What is claimed is:

1. A punch-free telescopic rod, comprising an inner tube and an outer tube, which are sleeved together, the inner tube extending into the ends of the outer tube, used as an insertion end and provided with a positioning member which is slidably connected with a first elastic part, so that the first elastic part can move back and forth along the positioning member in the same axial direction as the inner tube, and the first elastic part has static friction with the inner wall of the outer tube,
when the inner tube and the outer tube rotate relative to each other, the outer tube driving the first elastic part to move along the positioning member toward the insertion end of the inner tube until the first elastic part and the end face of the insertion end relatively squeeze each other, which results that the first elastic part can be elastically deformed, pressing against the inner wall of the outer tube so that the inner tube and the outer tube are mutually locked, avoiding relative axial displacement between the two;
when the inner tube and the outer tube rotate in opposite directions relative to each other, the outer tube drives the first elastic part to move away from the insertion end along the positioning member until the first elastic part and the end face of the insertion end are separated, and the first elastic part restores from the elastic deformation to unlock the outer tube and the inner tube, allowing movement of both the outer tube and the inner tube.

2. The punch-free telescopic rod according to claim 1, wherein the positioning member includes a threaded stud which is located in the center of the insertion end and has the same coaxial direction as the inner tube and a threaded sleeve which is provided with an internally-threaded hole, the two can be screwed together, the first elastic part being able to be connected to the end of the threaded sleeve facing the insertion end.

3. The punch-free telescopic rod according to claim 2, wherein the first elastic part includes a base and a plurality of elastic sheets distributed around the base at a certain interval, the base being provided with a through hole, and connected to the end of the threaded sleeve; the through hole and the internally-threaded hole of the threaded sleeve being through to each other; and the plurality of elastic sheets being distributed along the base form a radial shape.

4. The punch-free telescopic rod according to claim 3, wherein the elastic sheets are disposed outwardly with respect to the base, a plurality of such elastic sheets forming an bowl-like structure.

5. The punch-free telescopic rod according to claim 3, wherein the positioning member also includes a second elastic part, having the same structure as the the first elastic part, and being movably sleeved over the threaded stud through the through hole, which is located opposite to the first elastic part; when the outer tube drives the first elastic part to move along the positioning member toward the insertion end of the inner tube, the elastic sheets of the first elastic part and the second elastic part squeeze each other, causing that the elastic sheets of both the first elastic part and the second elastic part deform and open at the same time, thus pressing against the inner wall of the outer tube.

6. The punch-free telescopic rod according to claim 5, wherein a limiting notch is formed between two adjacent elastic sheets of the first elastic part and the second elastic part, through which the elastic sheet of the elastic part on the opposite side may be inserted, forming a position-limited state; when the elastic sheets of the first elastic part and the second elastic part cross and are inserted into each other's limiting notch, the first elastic part and the second elastic part will not be able to rotate relative to each other.

7. The punch-free telescopic rod according to claim 6, wherein the elastic sheets are made of a metal, and capable of elastic deformation.

8. The punch-free telescopic rod according to claim 2, wherein the threaded sleeve is externally connected with a tube-like base body, a plurality of buffer blocks being distributed around the tube-like base body at a certain interval and tightly pressing against the inner wall of the outer tube.

9. The punch-free telescopic rod according to claim 8, wherein the buffer blocks are disposed radially outward, the outer diameter formed by the plurality of buffer blocks being larger than the outer diameter of each elastic part.

10. The punch-free telescopic rod according claim 9, wherein the plurality of buffer blocks can achieve a certain elastic deformation relative to the tube-like base body.
